(19) United States
(12) Patent Application Publication
(10) Pub. No.: US 2019/0191251 A1
(43) Pub. Date: Jun. 20, 2019

(54) DIAPHRAGM AND ELECTROACOUSTIC TRANSDUCER

(71) Applicant: AUDIO-TECHNICA CORPORATION, Tokyo (JP)

(72) Inventor: Hiromichi OZAWA, Kanagawa (JP)

(21) Appl. No.: 16/160,246

(22) Filed: Oct. 15, 2018

(30) Foreign Application Priority Data
Dec. 18, 2017 (JP) 2017-242008
Jul. 20, 2018 (JP) 2018-136406

(51) Int. Cl. H04R 7/12; H04R 7/18

(52) U.S. Cl. CPC H04R 7/122; H04R 9/025; H04R 7/18; H04R 7/127

(57) ABSTRACT

A diaphragm and an electroacoustic transducer that suppress the influence to the lowest resonant frequency and enhance the mechanical strength includes a main dome, an auxiliary dome extending from an outer peripheral edge of the main dome, and a reinforcing member disposed on a boundary between the main dome and the auxiliary dome. The reinforcing member is disposed so as not to reach an outer peripheral edge of the auxiliary dome.

### TECHNICAL FIELD

The present invention relates to a diaphragm and an electroacoustic transducer.

### BACKGROUND ART

Electroacoustic transducers which interconvert between electric signals and sound waves are incorporated into electroacoustic transducer apparatuses such as headphones, microphones, and speakers. The electroacoustic transducer generates the sound waves in response to the electric signals by vibration of a diaphragm based on the electric signals or generates the electric signals in response to the sound waves by vibration of the diaphragm based on the sound waves.

The conversion types of the electroacoustic transducers include a dynamic type using a magnetic field and a condenser type using an electric field.

A dynamic electroacoustic transducer includes a magnetic circuit, a voice coil, and a diaphragm. The magnetic circuit generates a magnetic field. The voice coil is a conductor disposed in the magnetic field of the magnetic circuit and is attached to the diaphragm. The diaphragm generates sound waves by being vibrated by a driving force generated when flowing electric signals (currents) in the voice coil, or generates an electric signal in the voice coil by vibrating with the voice coil when receiving sound waves.

The diaphragm includes a vibrating portion and an attaching portion. The diaphragm is formed by pressurizing or heating of thin films such as polymer films. The vibrating portion includes a main dome and an auxiliary dome. The main dome has a circular dome shape in plan view. The auxiliary dome has an annular shape and a dome shape in plan view. The auxiliary dome continues to an outer peripheral edge of the main dome. The attaching portion continues to an outer peripheral edge of the auxiliary dome. That is, the main dome, the auxiliary dome, and the attaching portion are integrally formed.

In general, the diaphragm includes a thin film to reduce stiffness of the diaphragm. Thus, the mechanical strength of the diaphragm is likely to be low. As a result, the main dome can be readily deformed by an applied acoustic pressure or the driving force of the voice coil. If the mechanical strength of the diaphragm is low, the quality of sound output from the diaphragm decreases.

With respect to methods of enhancing the mechanical strength of the diaphragm, methods have been proposed to adhere a reinforcing film (reinforcing member) onto one face of the diaphragm (for example, refer to Japanese Unexamined Patent Application Publication No. 1980-137797), and to increase the thickness of the diaphragm (for example, refer to Japanese Unexamined Patent Application Publication No. 2008-85985).

### SUMMARY OF INVENTION

### Technical Problem

The lowest resonant frequency (f₀) of the diaphragm is varied by the influence of adhering the reinforcing member to the entire vibrating portion, in particular, along the outer peripheral edge of the auxiliary dome or increasing the thickness of the diaphragm in order to enhance the mechanical strength of the diaphragm. If the lowest resonant frequency is varied, the characteristics of the diaphragm in the low frequency range are deteriorated.

An object of the present invention is to solve the problem described above and provide a diaphragm and an electroacoustic transducer that suppress the influence to the lowest resonant frequency and enhance the mechanical strength.

### Solution to Problem

A diaphragm according to the present invention includes a main dome, an auxiliary dome continuing to the outer peripheral edge of the main dome, and a reinforcing member disposed on a boundary between the main dome and the auxiliary dome. The reinforcing member is disposed so as not to reach the outer peripheral edge of the auxiliary dome.

### Advantageous Effect of Problem

According to the present invention, the influence to the lowest resonant frequency can be suppressed and the mechanical strength can be enhanced.

### BRIEF DESCRIPTION OF DRAWING

FIG. 1 is a perspective view of an exemplary electroacoustic transducer apparatus including an electroacoustic transducer according to the present invention.

FIG. 2 is a left side view of the electroacoustic transducer apparatus in FIG. 1.

FIG. 3 is a cross-sectional view of the electroacoustic transducer apparatus taken along line A-A in FIG. 2.

FIG. 4 represents a plan view illustrating an embodiment of a diaphragm according to the present invention, and a cross-sectional view of the diaphragm taken along line B-B in the plan view of FIG. 4.

FIG. 5 is a graph illustrating frequency characteristics of the electroacoustic transducer according to the present invention.

FIG. 6 is a cross-sectional view of a diaphragm illustrating another aspect of a reinforcing member included in the diaphragm according to the present invention.

FIG. 7 is a cross-sectional view of a diaphragm illustrating still another aspect of the reinforcing member.

FIG. 8 represents a plan view illustrating another embodiment of a diaphragm according to the present invention, and a cross-sectional view of the diaphragm taken along line C-C in the plan view of FIG. 8.

FIG. 9 is a cross-sectional view of a diaphragm illustrating another aspect of the reinforcing member.

FIG. 10 is a cross-sectional view of a diaphragm illustrating still another aspect of the reinforcing member.

FIG. 11 is a cross-sectional view of a diaphragm illustrating still another aspect of the reinforcing member.

FIG. 12 is a cross-sectional view of a diaphragm illustrating still another aspect of the reinforcing member.

FIG. 13 represents a plan view illustrating still another embodiment of a diaphragm according to the present invention, a cross-sectional view of the diaphragm taken along line D-D in the plan view of FIG. 13, and a bottom view of the diaphragm.

FIG. 14 is a cross-sectional view of a diaphragm illustrating another aspect of the reinforcing member.

### DESCRIPTION OF EMBODIMENTS

Embodiments of a diaphragm and an electroacoustic transducer will now be described with reference to the attached drawings.

### Electroacoustic Transducer Apparatus (1)

An electroacoustic transducer apparatus including an electroacoustic transducer according to the present invention (hereinafter referred to as “present apparatus”) will now be described.

The present apparatus is an electroacoustic transducer apparatus, for example, headphones, ear phones, and speakers, that outputs sound waves based on sound signals from sound sources such as portable music players. In the following description, the present apparatus will be described by taking a headphone as an example.

### Configuration of Electroacoustic Transducer Apparatus (1)

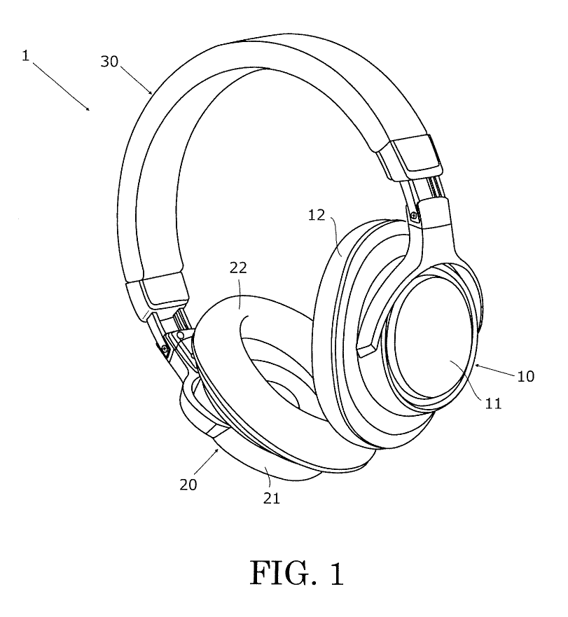

FIG. 1 is a perspective view of a present apparatus.

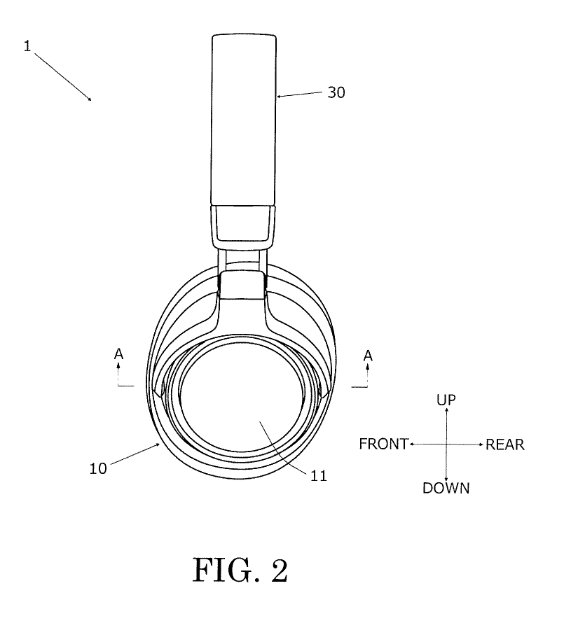

FIG. 2 is a left side view of a present apparatus.

A present apparatus 1 is worn on the head of a user and outputs sound waves based on the sound signals from a sound source. The present apparatus 1 is, for example, a wired headphone that receives sound signals from a sound source via cables (not shown).

The present apparatus may be a wireless headphone that receives sound signals from a sound source via wireless transmission such as Bluetooth (registered trademark).

In the following description, the top, bottom, right, left, front, and rear directions of the present apparatus 1 are the same as the top, bottom, right, left, front, and rear directions of the user wearing the present apparatus 1.

The present apparatus 1 includes a first sound emission unit 10, a second sound emission unit 20, and a connection member 30.

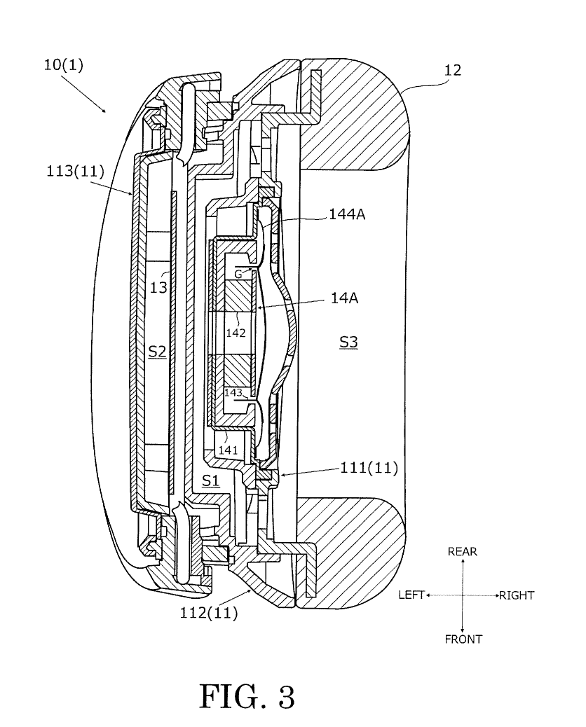

FIG. 3 is a cross-sectional view of the first sound emission unit 10 taken along line A-A in FIG. 2.

The first sound emission unit 10 is worn over the left ear of the user and outputs sound waves based on the sound signals from a sound source. The first sound emission unit 10 includes a housing 11, an ear pad 12, a circuit board 13, and an electroacoustic transducer 14A.

The housing 11 accommodates the circuit board 13 and the electroacoustic transducer 14A. The housing 11 includes a baffle plate 111, a first housing 112, and a second housing 113.

The baffle plate 111 holds the electroacoustic transducer 14A. The first housing 112 defines a first housing chamber S1 accommodating the electroacoustic transducer 14A together with the baffle plate 111. The second housing 113 defines a second housing chamber S2 accommodating the circuit board 13 together with the first housing 112.

The ear pad 12 is a buffer disposed between the housing 11 and the head of the user. The ear pad 12 defines a closed space S3 between the housing 11 and the head of the user (hereinafter referred to as “front air chamber”) when the present apparatus 1 is worn on the head of the user.

The circuit board 13 is provided with such as a circuit for receiving the sound signals and a circuit for noise cancellation. The circuit board 13 is disposed in the second housing chamber S2.

The circuit board is not an essential configuration in the present invention. The first sound emission unit may not include the circuit board. In that case, the second chamber is not required.

The electroacoustic transducer 14A generates sound waves based on electric signals (sound signals) from a sound source and outputs the sound waves to the front air chamber S3. The electroacoustic transducer 14A is attached to the baffle plate 111 and is disposed in the first housing chamber S1. The configuration of the electroacoustic transducer 14A will be described below.

Referring back to FIG. 1, the second sound emission unit 20 is worn over the right ear of the user and outputs sound waves based on the sound signals from a sound source. The second sound emission unit 20 has the same configuration as the configuration of the first sound emission unit 10. That is, the second sound emission unit 20 includes a housing 21, an ear pad 22, a circuit board (not shown), and an electroacoustic transducer (not shown).

The connection member 30 connects the first sound emission unit 10 and the second sound emission unit 20.

### Configuration of Electroacoustic Transducer (1)

An electroacoustic transducer according to the present invention will now be described. The electroacoustic transducer (not shown) included in the second sound emission unit 20 has the same configuration as the configuration of the electroacoustic transducer 14A included in the first sound emission unit 10. An exemplary configuration of the electroacoustic transducer 14A of the first sound emission unit 10 will be described below.

The electroacoustic transducer 14A includes a unit case 141, a magnetic circuit 142, a voice coil 143, and a diaphragm 144A.

The unit case 141 accommodates the magnetic circuit 142, the voice coil 143, and the diaphragm 144A. The unit case 141 is attached to the baffle plate 111.

The magnetic circuit 142 generates a magnetic field. The magnetic circuit 142 includes a magnetic gap G through which a magnetic flux with a uniform density passes.

The voice coil 143 is configured to drive (vibrate) in response to the sound signals. The voice coil 143 is attached to the rear face of the diaphragm 144A (the left face in FIG. 3). The voice coil 143 is disposed in the magnetic gap G so as to traverse the magnetic flux.

The diaphragm 144A is configured to vibrate in response to driving (vibration) of the voice coil 143 and to output sound waves. The diaphragm 144A is a thin circular film in plan view. The diaphragm 144A is a film composed of a synthetic resin such as polypropylene or polyethylene, for example. The configuration of the diaphragm 144A will be described below.

### Configuration of Diaphragm (1)

The diaphragm according to the present invention will now be described.

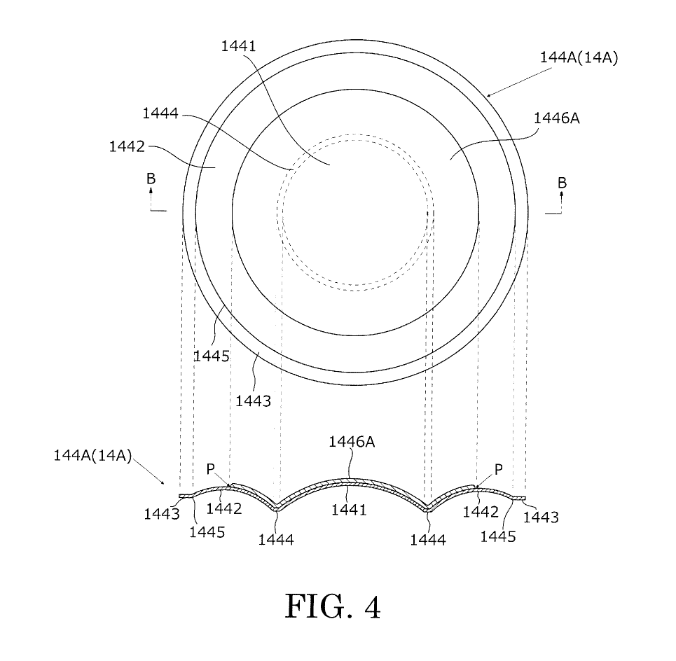

FIG. 4 illustrates an embodiment of the diaphragm according to the present invention. FIG. 4 represents a plan view of the diaphragm, and a cross-sectional view of the diaphragm taken along line B-B in the plan view of FIG. 4.

The diaphragm 144A includes a main dome 1441, an auxiliary dome 1442, an attaching portion 1443, a boundary 1444, a boundary 1445, and a reinforcing member 1446A. The main dome 1441, the auxiliary dome 1442, the attaching portion 1443, the boundary 1444, and the boundary 1445 are integrally formed by heat pressing. The diaphragm 144A includes the boundary 1444 between the main dome 1441 and the auxiliary dome 1442, and includes the boundary 1445 between the auxiliary dome 1442 and the attaching portion 1443.

The main dome 1441, the auxiliary dome 1442, and the boundary 1444 constitute a vibrating portion vibrating based on driving of the voice coil 143. The main dome 1441 has a circular shape in plan view and a dome shape convex to the right (the right in FIG. 3) in cross-sectional view. The auxiliary dome 1442 has an annular shape in plan view and an arcuate shape convex to the right in cross-sectional view. The auxiliary dome 1442 continues to the outer peripheral edge of the main dome. That is, the auxiliary dome 1442 is disposed along the outer peripheral edge of the main dome 1441. A line connecting boundary 1444 between the main dome 1441 and the auxiliary dome 1442 (an imaginary line) has a circular shape in plan view. The auxiliary dome 1442 has a top part P. The top part P is the top of the auxiliary dome 1442.

The width of the boundary (in the horizontal direction in the cross-sectional view of FIG. 4) is appropriately determined according to the application and the size of the diaphragm.

The attaching portion 1443 is attached to the unit case 141. The diaphragm 144A can vibrate relative to the unit case 141. The attaching portion 1443 has an annular shape in plan view and a flat plate shape in cross-sectional view. The attaching portion 1443 continues to an outer peripheral edge of the auxiliary dome 1442. That is, the attaching portion 1443 is disposed along the outer peripheral edge of the auxiliary dome 1442. A line connecting the boundary 1445 between the auxiliary dome 1442 and the attaching portion 1443 (an imaginary line) has a circular shape in plan view.

The reinforcing member 1446A reinforces the vibrating portion to enhance (increase) the mechanical strength of the vibrating portion.

The reinforcing member 1446A covers the entirety of the front face of the main dome 1441 (the upper face in the cross-sectional view of FIG. 4), the boundary 1444, and part of the front face of the auxiliary dome 1442. The reinforcing member 1446A has a circular shape in plan view. The reinforcing member 1446A is a thin film composed of a thermoplastic resin such as polycarbonate, for example. That is, a material of the reinforcing member 1446A is different from a material of the vibrating portion.

The material of the reinforcing member may be the same as the material of the vibrating portion as long as the material that can reinforce the vibrating portion.

The reinforcing member 1446A is adhered to a front face of the vibrating portion (the upper face in the cross-sectional view of FIG. 4) with an adhesive (not shown). The adhesive is an ultraviolet (UV) curing-type adhesive, for example.

The adhesive is not limited to an UV curing-type adhesive as long as an adhesive which can adhere the reinforcing member to the vibrating portion.

The configuration of the reinforcing member is not limited to the embodiment. That is, the reinforcing member may have a configuration including a mesh for the entire or only part of the reinforcing member, and/or may include a groove, hole, or opening for flowing out an excessive adhesive.

As shown in the cross-sectional view of FIG. 4, the reinforcing member 1446A is disposed on the front face of the entire main dome 1441, the boundary 1444, and part of the auxiliary dome 1442 (on the upper face in the cross-sectional view of FIG. 4). The reinforcing member 1446A is disposed so as not to reach the outer peripheral edge of the auxiliary dome 1442. That is, the reinforcing member 1446A is not disposed along the boundary 1445. In other words, the reinforcing member 1446A is not disposed along the outer peripheral edge of the auxiliary dome 1442. Thus, the reinforcing member 1446A is adhered to the entire main dome 1441, the boundary 1444, and part of the auxiliary dome 1442 with an adhesive (not shown).

The expression “the reinforcing member 1446A is disposed so as not to reach the outer peripheral edge of the auxiliary dome 1442” indicates that an outer peripheral edge of the reinforcing member 1446A having a circular shape in plan view are disposed in the auxiliary dome 1442 more inwardly (the boundary 1444 side) than the boundary 1445. That is, the outer peripheral edge of the reinforcing member 1446A is disposed on the auxiliary dome 1442 disposed between the boundary 1444 and the boundary 1445.

As shown in the cross-sectional view of FIG. 4, the outer peripheral edge of the reinforcing member 1446A is disposed so as to extend to the top part P of the auxiliary dome 1442. That is, the reinforcing member 1446A is disposed on the main dome 1441, the boundary 1444, and part of the auxiliary dome 1442.

The outer peripheral edge of the reinforcing member is preferably disposed near the top part P of the auxiliary dome 1442, for example. The phrase “near the top part P” is the area from “the intermediary position between the top part P and the boundary 1444” of the auxiliary dome 1442 to “the intermediary position between the top part P and the boundary 1445”. In other words, “near the peak P” includes an area extending inwardly from the top part P (the intermediary position side between the top part P and the boundary 1444) and an area extending outwardly from the top part P (the intermediary position side between the top part P and the boundary 1445).

### Operation of Electroacoustic Transducer (1)

The operation of the electroacoustic transducer according to the present invention will now be described.

The diaphragm 144A is configured to vibrate in response to driving (vibration) of the voice coil 143 and to output sound waves. The reinforcing member 1446A is disposed on the entire main dome 1441, the boundary 1444, and part of the auxiliary dome 1442. Thus, the mechanical strength of the diaphragm 144A is enhanced. Furthermore, the reinforcing member 1446A is disposed so as not to reach the outer peripheral edge of the auxiliary dome 1442. Thus, the influence to the lowest resonant frequency of the diaphragm 144A (for example, an increase in the lowest resonant frequency) is suppressed.

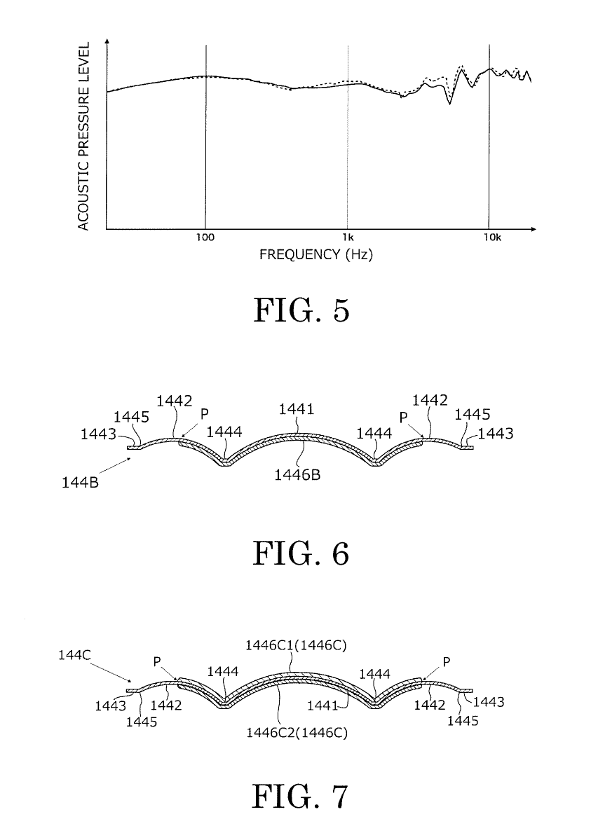

FIG. 5 is a graph illustrating frequency characteristics of the electroacoustic transducer according to the present invention.

FIG. 5 shows a results of comparison between the frequency characteristics of a conventional electroacoustic transducer (hereinafter referred to as “conventional product”) and the frequency characteristics of the electroacoustic transducer according to the present invention.

In FIG. 5, the solid line indicates the frequency characteristics of the electroacoustic transducer 14A according to the present invention whereas the dotted line indicates the frequency characteristics of the conventional product. As shown in FIG. 5, the frequency characteristics of the electroacoustic transducer 14A and the frequency characteristics of the conventional product are almost comparable in the low frequency range. That is, although the electroacoustic transducer 14A includes the reinforcing member 1446A, the influence to the lowest resonant frequency of the diaphragm 144A is suppressed. In the frequency characteristics of the electroacoustic transducer 14A, the acoustic pressure outputted from the diaphragm is reduced in the middle and high frequency ranges compared to the frequency characteristics of the conventional product. In other words, the electroacoustic transducer 14A has the excellent frequency characteristics because the resonance of the diaphragm 144A is avoided and the frequency characteristics in the middle and high frequency ranges are improved compared to the conventional product.

### Synopsis (1)

According to the embodiment described above, the diaphragm 144A of the electroacoustic transducer 14A includes the reinforcing member 1446A on the vibrating portion. Thus, the mechanical strength of the diaphragm 144A is enhanced. The reinforcing member 1446A is disposed so as not to reach the outer peripheral edge of the auxiliary dome 1442. Thus, the influence to the lowest resonant frequency of the diaphragm 144A is suppressed. That is, the diaphragm 144A can suppress the influence to the lowest resonant frequency and enhance the mechanical strength of the diaphragm 144A.

The reinforcing member may have a configuration adhered to the rear face of the vibrating portion (the left face in FIG. 3) with an adhesive instead of the front face of the vibrating portion.

FIG. 6 is a cross-sectional view of a diaphragm illustrating another aspect of the reinforcing member.

FIG. 6 shows an embodiment where a reinforcing member is adhered to the rear face of the vibrating portion (the lower face in FIG. 6).

A diaphragm 144B includes a main dome 1441, an auxiliary dome 1442, an attaching portion 1443, a boundary 1444, a boundary 1445, and a reinforcing member 1446B.

As shown in FIG. 6, the reinforcing member 1446B is disposed on the rear faces of the entire main dome 1441, the boundary 1444, and part of the auxiliary dome 1442. The reinforcing member 1446B is disposed so as not to reach the outer peripheral edge of the auxiliary dome 1442. That is, the reinforcing member 1446B is not disposed along the boundary 1445. In other words, the reinforcing member 1446B is not disposed along the outer peripheral edge of the auxiliary dome 1442. Thus, the reinforcing member 1446B is adhered to the entire main dome 1441, the boundary 1444, and part of the auxiliary dome 1442 with an adhesive (not shown). The reinforcing member 1446B has a circular shape in plan view, similar to the reinforcing member 1446A described above.

The diaphragm 144B including such a reinforcing member 1446B also achieves the same effect as the diaphragm 144A described above.

The reinforcing member may have a configuration adhered to the front face of the vibrating portion and the rear face of the vibrating portion with an adhesive.

FIG. 7 is a cross-sectional view of a diaphragm illustrating still another aspect of the reinforcing member.

FIG. 7 shows a reinforcing member adhered to the front face of the vibrating portion (the upper face in FIG. 7) and the rear face of the vibrating portion (the lower face in FIG. 7). That is, FIG. 7 shows a first reinforcing member adhered to the front face of the vibrating portion and a second reinforcing member adhered to the rear face of the vibrating portion.

A diaphragm 144C includes a main dome 1441, an auxiliary dome 1442, an attaching portion 1443, a boundary 1444, a boundary 1445, and a reinforcing member 1446C.

The reinforcing member 1446C includes a first reinforcing member 1446C1 and a second reinforcing member 1446C2. The shape of the first reinforcing member 1446C1 is the same as the shape of the second reinforcing member 1446C2. The position of the outer peripheral edge (outer end portion) of the first reinforcing member 1446C1 is coincident with the position of the outer peripheral edge (outer end portion) of the second reinforcing member 1446C2.

The position of the outer peripheral edge (outer end portion) of the first reinforcing member may not be coincident with the position of the outer peripheral edge (outer end portion) of the second reinforcing member. That is, as long as the outer peripheral edge (outer end portion) of the first reinforcing member and the outer peripheral edge (outer end portion) of the second reinforcing member are respectively disposed near the top part of the auxiliary dome, the outer peripheral edge (outer end portion) of the first reinforcing member may be disposed more outwardly than the outer peripheral edge (outer end portion) of the second reinforcing member, or the outer peripheral edge (outer end portion) of the first reinforcing member may be disposed more inwardly than the outer peripheral edge (outer end portion) of the second reinforcing member, for example.

As shown in FIG. 7, the first reinforcing member 1446C1 is disposed on the front faces of the entire main dome 1441, the boundary 1444 and part of the auxiliary dome 1442. The first reinforcing member 1446C1 is disposed so as not to reach the outer peripheral edge on the front face of the auxiliary dome 1442. As shown in FIG. 7, the second reinforcing member 1446C2 is disposed on the rear faces of the entire main dome 1441, the boundary 1444, and part of the auxiliary dome 1442. The second reinforcing member 1446C2 is disposed so as not to reach the outer peripheral edge on the rear face of the auxiliary dome 1442. That is, neither the first reinforcing member 1446C1 nor the second reinforcing member 1446C2 are disposed along the boundary 1445. In other words, neither the first reinforcing member 1446C1 nor the second reinforcing member 1446C2 are disposed along the outer peripheral edge of the auxiliary dome 1442. The first reinforcing member 1446C1 is adhered to the entire main dome 1441, the boundary 1444, and part of the auxiliary dome 1442 with an adhesive (not shown). The second reinforcing member 1446C2 is adhered to the entire main dome 1441, the boundary 1444, and part of the auxiliary dome 1442 with an adhesive (not shown). Both of the first reinforcing member 1446C1 and the second reinforcing member 1446C2 have a circular shape in plan view, similar to the reinforcing member 1446A described above.

The diaphragm 144C including such a reinforcing member 1446C achieves the same effect as the diaphragm 144A as described above.

As described above, the reinforcing member included in the diaphragm according to the present invention includes one reinforcing member (the first reinforcing member) disposed on the front face of the boundary 1444 and another reinforcing member (the second reinforcing member) disposed on the rear face of the boundary 1444.

### Electroacoustic Transducer Apparatus, Electroacoustic Transducer, and Diaphragm (2)

Another embodiment of the electroacoustic transducer and the diaphragm according to the present invention (hereinafter referred to as “second embodiment”) will now be described, focusing on differences from the embodiment (hereinafter referred to as “first embodiment”) described above. The electroacoustic transducer in the second embodiment differs from the first embodiment in the shape and position of the reinforcing member of the diaphragm.

The electroacoustic transducer apparatus of the second embodiment includes an electroacoustic transducer of the second embodiment. The electroacoustic transducer of the second embodiment includes a diaphragm of the second embodiment. That is, the electroacoustic transducer apparatus of the second embodiment has an electroacoustic transducer including the diaphragm of the second embodiment.

In the second embodiment, the diaphragm has a different configuration from the diaphragm of the first embodiment, whereas the electroacoustic transducer apparatus and the electroacoustic transducer have the same configurations as the electroacoustic transducer apparatus and the electroacoustic transducer of the first embodiment.

The reinforcing member included in the diaphragm of the second embodiment is disposed only on the boundary between the main dome and the auxiliary dome, part of the main dome, and part of the auxiliary dome. Meanwhile, the reinforcing member, which the diaphragm of the first embodiment includes, is disposed not only on the boundary between the main dome and the auxiliary dome, but also on the entire main dome and part of the auxiliary dome.

### Configuration of Diaphragm (2)

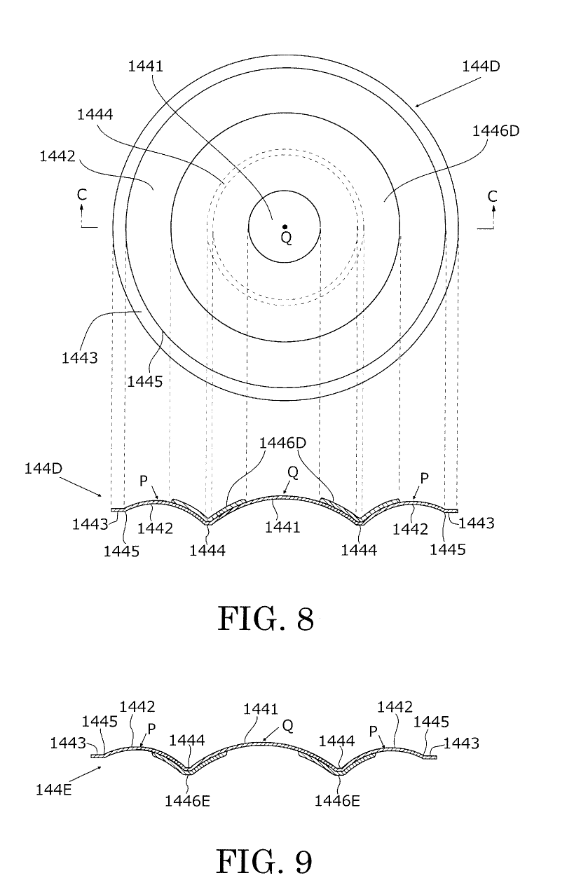

FIG. 8 illustrates another embodiment of a diaphragm according to the present invention. FIG. 8 represents a plan view, and a cross-sectional view taken along line C-C in the plan view of FIG. 8.

In FIG. 8, components denoted by the same reference numerals as the components of the first embodiment include the same functions as the components of the first embodiment.

A diaphragm 144D includes a main dome 1441, an auxiliary dome 1442, an attaching portion 1443, a boundary 1444, a boundary 1445, and a reinforcing member 1446D.

As shown in the cross-sectional view of FIG. 8, the reinforcing member 1446D is disposed on the front faces (the upper faces in the cross-sectional view of FIG. 8) of the boundary 1444, part of the main dome 1441 and part of the auxiliary dome 1442 interposing the boundary 1444 therebetween. The reinforcing member 1446D is disposed so as not to reach the outer peripheral edge of the auxiliary dome 1442, and is disposed not near a top part Q of the main dome 1441. That is, the reinforcing member 1446D is disposed only on the boundary 1444, part of the main dome 1441 and part of the auxiliary dome 1442 interposing the boundary 1444 therebetween, and is disposed not on the boundary 1445. In other words, the reinforcing member 1446D is not disposed on the outer peripheral edge of the auxiliary dome 1442. The top part Q is the top of the main dome 1441.

The reinforcing member 1446D is adhered to the boundary 1444, part of the main dome 1441 and part of the auxiliary dome 1442 interposing the boundary 1444 therebetween with an adhesive (not shown). That is, the reinforcing member 1446D is adhered to part of the front face of the vibrating portion. As shown in the plan view of FIG. 8, the reinforcing member 1446D has an annular shape in plan view.

The expression “a reinforcing member 1446D is not disposed on a top part Q of the main dome 1441” indicates that the inner peripheral edge of the reinforcing member 1446D having an annular shape in plan view is disposed between the top part Q of the main dome 1441 and the boundary 1444. “Part of the main dome 1441 and part of the auxiliary dome 1442 interposing the boundary 1444 therebetween” is referred to as a position near the top part Q rather than the intermediary position between the top part Q and the boundary 1444, and a position near the top part P rather than the intermediary position between the top part P and the boundary 1444. That is, “part of the main dome 1441 and part of the auxiliary dome 1442 interposing the boundary 1444 therebetween” is referred to as an area from near the boundary 1444 rather than the top part P to near the boundary 1444 rather than the top part Q.

### Synopsis (2)

According to the second embodiment described above, the diaphragm 144D can suppress the influence to the lowest resonant frequency and enhance the mechanical strength of the diaphragm 144D, similar to the first embodiment.

In the second embodiment, the reinforcing member may have a configuration adhered to the rear face of the vibrating portion instead of the front face of the vibrating portion with an adhesive.

FIG. 9 is a cross-sectional view of a diaphragm illustrating another aspect of the reinforcing member.

FIG. 9 shows an embodiment where a reinforcing member is adhered to the rear face of a vibrating portion (the lower face in FIG. 9).

A diaphragm 144E includes a main dome 1441, an auxiliary dome 1442, an attaching portion 1443, a boundary 1444, a boundary 1445, and a reinforcing member 1446E.

As shown in FIG. 9, the reinforcing member 1446E is disposed on the rear faces of the boundary 1444, part of the main dome 1441 and part of the auxiliary dome 1442 interposing the boundary 1444 therebetween. The reinforcing member 1446E is disposed so as not to reach the outer peripheral edge of the auxiliary dome 1442, and is disposed not near the top part Q of the main dome 1441. That is, the reinforcing member 1446E is disposed only on the boundary 1444, part of the main dome 1441 and part of the auxiliary dome 1442 interposing the boundary 1444 therebetween, and is disposed not on the boundary 1445. In other words, the reinforcing member 1446E is not disposed on the outer peripheral edge of the auxiliary dome 1442. The reinforcing member 1446E is adhered to the boundary 1444 and near the boundary 1444 with an adhesive (not shown). The reinforcing member 1446E has an annular shape in plan view, similar to the reinforcing member 1446D described above.

The diaphragm 144E including such a reinforcing member 1446E achieves the same effect as the diaphragm 144A described above.

The reinforcing member may have a configuration adhered to the front face of the vibrating portion and the rear face of the vibrating portion with an adhesive.

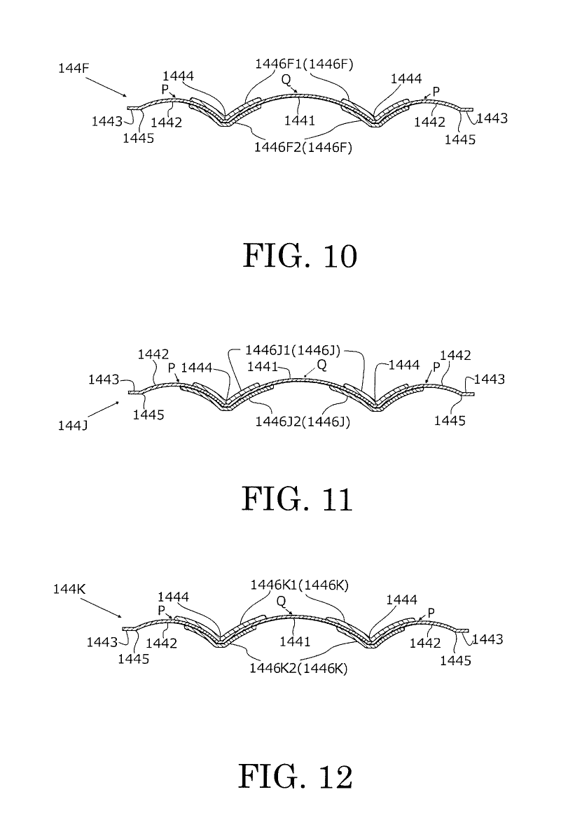

FIG. 10 is a cross-sectional view of a diaphragm illustrating still another aspect of the reinforcing member.

FIG. 10 shows reinforcing members adhered to the front face of the vibrating portion (the upper face in FIG. 10) and the rear face of the vibrating portion (the lower face in FIG. 10). That is, FIG. 10 indicates a first reinforcing member adhered to the front face of the vibrating portion and a second reinforcing member adhered to the rear face of the vibrating portion.

A diaphragm 144F includes a main dome 1441, an auxiliary dome 1442, an attaching portion 1443, a boundary 1444, a boundary 1445, and a reinforcing member 1446F.

The reinforcing member 1446F includes a first reinforcing member 1446F1 and a second reinforcing member 1446F2. The shape of the first reinforcing member 1446F1 is the same as the shape of the second reinforcing member 1446F2. The positions of an inner peripheral edge (inner end portion) and an outer peripheral edge (outer end portion) of the first reinforcing member 1446F1 are coincident with the positions of an inner peripheral edge (inner end portion) and an outer peripheral edge (outer end portion) of the second reinforcing member 1446F2, respectively.

As shown in FIG. 10, the first reinforcing member 1446F1 is disposed on the front faces of the boundary 1444, part of the main dome 1441 and part of the auxiliary dome 1442 interposing the boundary 1444 therebetween. The first reinforcing member 1446F1 is disposed so as not to reach the outer peripheral edge on the front face of the auxiliary dome 1442 and is disposed not near the top part Q of the main dome 1441. As shown in FIG. 10, the second reinforcing member 1446F2 is disposed on the rear faces of the boundary 1444, part of the main dome 1441 and part of the auxiliary dome 1442 interposing the boundary 1444 therebetween. The second reinforcing member 1446F2 is disposed so as not to reach the outer peripheral edge on the front face of the auxiliary dome 1442 and is disposed not near the top part Q of the main dome 1441. That is, both the first reinforcing member 1446F1 and the second reinforcing member 1446F2 are disposed only on the boundary 1444, part of the main dome 1441 and part of the auxiliary dome 1442 interposing the boundary 1444 therebetween, and are disposed not on the boundary 1445. In other words, neither the first reinforcing member 1446F1 nor the second reinforcing member 1446F2 are disposed on the outer peripheral edge of the auxiliary dome 1442. The first reinforcing member 1446F1 is adhered to the boundary 1444, part of the main dome 1441 and part of the auxiliary dome 1442 interposing the boundary 1444 therebetween with an adhesive (not shown). The second reinforcing member 1446F2 is adhered to the boundary 1444, part of the main dome 1441 and part of the auxiliary dome 1442 interposing the boundary 1444 therebetween with an adhesive (not shown). Both the first reinforcing member 1446F1 and the second reinforcing member 1446F2 have an annular shape in plan view, similar to the reinforcing member 1446D described above.

The diaphragm 144F including such a reinforcing member 1446F achieves the same effect as the diaphragm 144A.

The shape of the first reinforcing member may be different from the shape of the second reinforcing member.

FIG. 11 is a cross-sectional view of a diaphragm illustrating still another aspect of the reinforcing member.

FIG. 11 shows an embodiment where the shape of reinforcing members adhered to the front face (the upper face in FIG. 11) of the vibrating portion is different from the shape of reinforcing members adhered to rear face (the lower face in FIG. 11) of the vibrating portion.

A diaphragm 144J includes a main dome 1441, an auxiliary dome 1442, an attaching portion 1443, a boundary 1444, a boundary 1445, and a reinforcing member 1446J.

The reinforcing member 1446J includes a first reinforcing member 1446J1 and a second reinforcing member 1446J2. The first reinforcing member 1446J1 has the same shape as the first reinforcing member 1446F1 in the second embodiment (see FIG. 10) and is disposed at the same position on the diaphragm 144J as the position of the reinforcing member 1446F1 on the diaphragm 144F.

As shown in FIG. 11, the second reinforcing member 1446J2 is disposed on the rear faces of the boundary 1444, the main dome 1441 and the auxiliary dome 1442 interposing the boundary 1444 therebetween. An outer peripheral edge of the second reinforcing member 1446J2 is disposed near the top part P rather than an outer peripheral edge of the first reinforcing member 1446J1. The second reinforcing member 1446J2 is disposed so as not to reach the outer peripheral edge on the rear face of the auxiliary dome 1442. Meanwhile, an inner peripheral edge of the second reinforcing member 1446J2 is disposed near the top part Q rather than an inner peripheral edge of the first reinforcing member 1446J1.

The diaphragm 144J including such a reinforcing member 1446J achieves the same effect as the diaphragm 144A.

FIG. 12 is a cross-sectional view of a diaphragm illustrating still another aspect of the reinforcing member.

FIG. 12 shows an embodiment where the shape of reinforcing members adhered to the front face (the upper face in FIG. 12) of a vibrating portion is different from the shape of the reinforcing members adhered to the rear face (the lower face in FIG. 12) of the vibrating portion.

A diaphragm 144K includes a main dome 1441, an auxiliary dome 1442, an attaching portion 1443, a boundary 1444, a boundary 1445, and a reinforcing member 1446K.

The reinforcing member 1446K includes a first reinforcing member 1446K1 and a second reinforcing member 1446K2. The first reinforcing member 1446K1 will be described below.

The second reinforcing member 1446K2 has the same shape as the second reinforcing member 1446F2 in the second embodiment (see FIG. 10) and is disposed at the same position on the diaphragm 144K as the position of the reinforcing member 1446F2 on the diaphragm 144F.

As shown in FIG. 12, the first reinforcing member 1446K1 is disposed on the front faces of the boundary 1444, the main dome 1441 and the auxiliary dome 1442 interposing the boundary 1444 therebetween. An outer peripheral edge of the first reinforcing member 1446K1 is disposed near the top part P rather than an outer peripheral edge of the second reinforcing member 1446K2. The first reinforcing member 1446K1 is disposed so as not to reach the outer peripheral edge on the front face of the auxiliary dome 1442. Meanwhile, an inner peripheral edge of the first reinforcing member 1446K1 are disposed near the top part Q rather than an inner peripheral edge of the second reinforcing member 1446K2.

### Electroacoustic Transducer Apparatus, Electroacoustic Transducer, and Diaphragm (3)

The other embodiment of the electroacoustic transducer and diaphragm according to the present invention (hereinafter referred to as “third embodiment”) will now be described, focusing on differences from the first embodiment and the second embodiment described above.

The electroacoustic transducer apparatus of the third embodiment includes an electroacoustic transducer of the third embodiment. The electroacoustic transducer of the third embodiment includes a diaphragm of the third embodiment. That is, the electroacoustic transducer apparatus of the third embodiment has the electroacoustic transducer including the diaphragm of the third embodiment.

In the third embodiment, the diaphragm has a different configuration from the diaphragms in the first embodiment and the second embodiment, while the electroacoustic transducer apparatus and the electroacoustic transducer have the same configurations as the electroacoustic transducer apparatuses and the electroacoustic transducer in the first embodiment and the second embodiment.

The reinforcing member included in the diaphragm of the third embodiment includes a first reinforcing member disposed on the front faces of the entire main dome, the boundary, and part of the auxiliary dome and a second reinforcing member disposed on the rear faces of the boundary, part of the main dome and part of the auxiliary dome interposing the boundary therebetween. The diaphragm of the third embodiment differs from the diaphragms of the first embodiment and the second embodiment in that the shape of the first reinforcing member is different from the shape of the second reinforcing member.

### Configuration of Diaphragm (3)

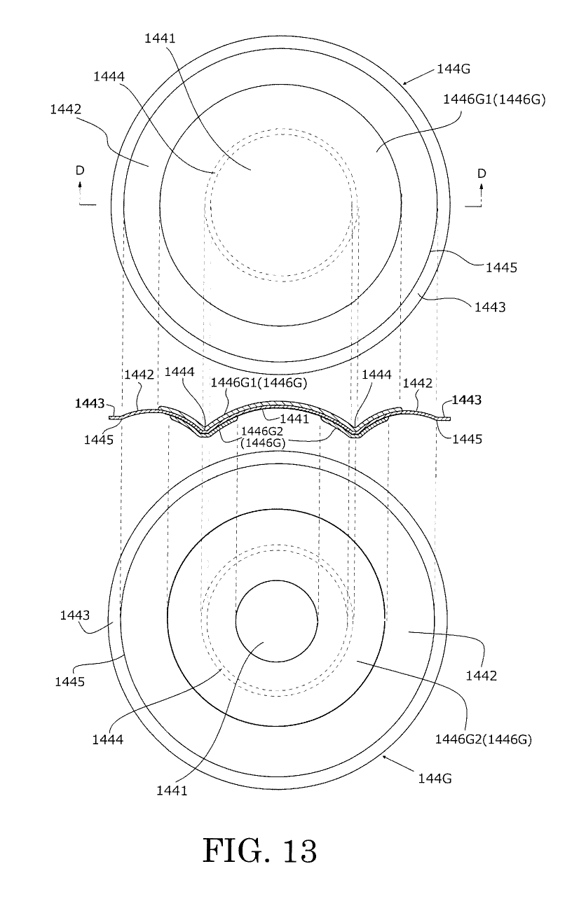

FIG. 13 illustrates still another embodiment of a diaphragm according to the present invention. FIG. 13 represents a plan view, a cross-sectional view taken along line D-D in the plan view of FIG. 13, and a bottom view.

In FIG. 13, components denoted by the same reference numerals as the components of the first embodiment include the same functions as the components of the first embodiment.

The diaphragm 144G includes a main dome 1441, an auxiliary dome 1442, an attaching portion 1443, a boundary 1444, a boundary 1445, and a reinforcing member 1446G.

The reinforcing member 1446G includes a first reinforcing member 1446G1 and a second reinforcing member 1446G2. The shape of the first reinforcing member 1446G1 is a different from the shape of the second reinforcing member 1446G2. The first reinforcing member 1446G1 has the same shape as the first reinforcing member 1446C1 in the first embodiment (see FIG. 7), and is disposed at the same position on the diaphragm 144G as the position of the reinforcing member 1446C1 on the diaphragm 144C. The second reinforcing member 1446G2 has the same shape as the second reinforcing member 1446F2 in the second embodiment (see FIG. 10) and is disposed at the same position on the diaphragm 144G as the position of the reinforcing member 1446F2 on the diaphragm 144F.

As shown in the cross-sectional view of FIG. 13, the first reinforcing member 1446G1 is disposed on the front faces (the upper faces in the cross-sectional view of FIG. 13) of the entire main dome 1441, the boundary 1444, and part of the auxiliary dome 1442. As shown in the cross-sectional view of FIG. 13, the second reinforcing member 1446G2 is disposed on the rear faces (the lower faces in the cross-sectional view of FIG. 13) of the boundary 1444, part of the main dome 1441 and part of the auxiliary dome 1442 interposing the boundary 1444 therebetween. That is, the reinforcing member 1446G is disposed on the front face and the rear face of the vibrating portion.

### Synopsis (3)

According to the embodiments described above, the diaphragm 144G of the third embodiment can suppress the influence to the resonant frequency and enhance the mechanical strength of the diaphragm 144G, similar to the first embodiment and the second embodiment.

The reinforcing member may have a configuration that the first reinforcing member and the second reinforcing member are disposed with their positions reversed in the third embodiment.

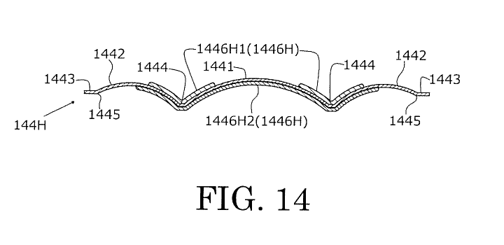

FIG. 14 is a cross-sectional view of a diaphragm illustrating another aspect of the reinforcing member.

FIG. 14 shows an embodiment where reinforcing members are adhered to the front face of a vibrating portion (the upper face in FIG. 14) and the rear face of the vibrating portion (the lower face in FIG. 14).

A diaphragm 144H includes a main dome 1441, an auxiliary dome 1442, an attaching portion 1443, a boundary 1444, a boundary 1445, and a reinforcing member 1446H.

The reinforcing member 1446H includes a first reinforcing member 1446H1 and a second reinforcing member 1446H2. The first reinforcing member 1446H1 has the same shape as the first reinforcing member 1446F1 in the second embodiment (see FIG. 10), and is disposed at the same position on the diaphragm 144H as the position of the reinforcing member 1446F1 on the diaphragm 144F. The second reinforcing member 1446H2 has the same shape as the second reinforcing member 1446C2 in the first embodiment (see FIG. 8), and is disposed at the same position on the diaphragm 144H as the position of the reinforcing member 1446C2 on the diaphragm 144C.

As shown in FIG. 14, the first reinforcing member 1446H1 is disposed on the front faces of the boundary 1444, part of the main dome 1441 and part of the auxiliary dome 1442 interposing the boundary 1444 therebetween. As shown in FIG. 14, the second reinforcing member 1446H2 is disposed on the rear faces of the entire main dome 1441, the boundary 1444, and part of the auxiliary dome 1442. That is, the reinforcing member 1446H is disposed on the front face and the rear face of the vibrating portion.

The diaphragm 144H including such a reinforcing member 1446H achieves the same effect as the diaphragm 144A described above.

### Synopsis (Miscellaneous)

In the diaphragm according to the present invention, the reinforcing member may have a configuration stacking thin films on at least one of the front face or rear face of the vibrating portion. That is, the thin films include a first thin film and a second thin film stacked on the first thin film, for example. In this case, the first thin film and the second thin film are bonded with an adhesive. As long as reinforcing the vibrating portion can enhance the mechanical strength of the vibrating portion, a material of the first thin film may be the same as or different from a material of the second thin film. Stacking the thin films is referred to as stacking “a thin film disposed remote from the vibrating portion (the second thin film)” on “a thin film disposed near the vibrating portion (the first thin film)”.

In the reinforcing member having a configuration of stacking thin films, the material of the second thin film is preferably tougher than the material of the first thin film. Such a configuration can more robustly reinforce the vibrating portion.

In the configuration including the first reinforcing member and the second reinforcing member, the material of the first reinforcing member may be different from the material of the second reinforcing member.

The embodiments described above are examples of the case when diaphragms according to the present invention are applied to headphones converting electric signals to sound waves. However, the diaphragms according to the present invention may be applied to electroacoustic transducers converting sound waves to electric signals. That is, the diaphragms according to the present invention are applicable to driver units used in microphone units, for example. In other words, the driver units vibrate the diaphragms according to the present invention in response to sound waves and generate electric signals based on this vibration. In this case, a driver unit is an example of the electroacoustic transducer according to the present invention. A microphone unit including this driver unit is an example of the present apparatus.

### Synopsis of Diaphragm and Electroacoustic Transducer According to the Present Invention

Configurational features of the diaphragm and electroacoustic transducer according to the present invention, and the electroacoustic transduction apparatus including the diaphragm and the electroacoustic transducer according to the present invention described above will be summarized below.

### (Feature 1)

A diaphragm comprising:

a main dome;

an auxiliary dome extending from an outer peripheral edge of the main dome; and

a reinforcing member disposed on a boundary between the main dome and the auxiliary dome, wherein

the reinforcing member is disposed so as not to reach an outer peripheral edge of the auxiliary dome.

### (Feature 2)

The diaphragm according to feature 1, wherein the outer peripheral edge of the reinforcing member is disposed near a top part of the auxiliary dome.

### (Feature 3)

The diaphragm according to feature 1, wherein the boundary has a circular shape, and the reinforcing member has an annular shape.

### (Feature 4)

The diaphragm according to feature 1, wherein the reinforcing member is not disposed on a top part of the main dome.

### (Feature 5)

The diaphragm according to feature 1, wherein the reinforcing member is or includes a mesh part.

### (Feature 6)

The diaphragm according to feature 1, wherein a material of the reinforcing member is different from a material of the auxiliary dome.

### (Feature 7)

The diaphragm according to feature 1, wherein the reinforcing member includes at least one of;

a first reinforcing member disposed on a front face of the boundary; and

a second reinforcing member disposed on a rear face of the boundary.

### (Feature 8)

The diaphragm according to feature 7, wherein

the reinforcing member comprises both the first reinforcing member and the second reinforcing member, and

wherein a material of the first reinforcing member is different from a material of the second reinforcing member.

### (Feature 9)

The diaphragm according to feature 7, wherein

the reinforcing member comprises both the first reinforcing member and the second reinforcing member, and

wherein a shape of the first reinforcing member is a different from a shape of the second reinforcing member.

### (Feature 10)

The diaphragm according to claim 7, wherein

one or more of the first reinforcing member and the second reinforcing member is not disposed near the top part of the main dome.

### (Feature 11)

The diaphragm according to feature 1, wherein the reinforcing member includes a first thin film and a second thin film stacked on the first thin film.

### (Feature 12)

The diaphragm according to feature 11, wherein a material of the first thin film is different from a material of the second thin film.

### (Feature 13)

An electroacoustic transducer converting electric signals to sound waves or converting sound waves to electric signals, comprising:

a diaphragm configured to vibrate in response to the electric signals or to vibrate in response to the sound waves, wherein

the diaphragm is the diaphragm according to feature 1.

### (Feature 14)

An electroacoustic transducer apparatus comprising:

an electroacoustic transducer converting electric signals to sound waves or converting sound waves to electric signals, wherein

the electroacoustic transducer is the electroacoustic transducer according to feature 13.

1. A diaphragm comprising:
a main dome;
an auxiliary dome extending from an outer peripheral edge of the main dome; and
a reinforcing member disposed on a boundary between the main dome and the auxiliary dome, wherein
the reinforcing member is disposed so as not to reach an outer peripheral edge of the auxiliary dome.

2. The diaphragm according to claim 1, wherein the outer peripheral edge of the reinforcing member is disposed near a top part of the auxiliary dome.

3. The diaphragm according to claim 1, wherein
the boundary has a circular shape, and
the reinforcing member has an annular shape.

4. The diaphragm according to claim 1, wherein a material of the reinforcing member is different from a material of the auxiliary dome.

5. The diaphragm according to claim 1, wherein the reinforcing member comprises at least one of;
a first reinforcing member disposed on a front face of the boundary; and
a second reinforcing member disposed on a rear face of the boundary.

6. The diaphragm according to claim 5, wherein
the reinforcing member comprises both the first reinforcing member and the second reinforcing member, and
wherein a material of the first reinforcing member is different from a material of the second reinforcing member.

7. The diaphragm according to claim 5, wherein
the reinforcing member comprises both the first reinforcing member and the second reinforcing member, and
a shape of the first reinforcing member is different from a shape of the second reinforcing member.

8. The diaphragm according to claim 5, wherein
one or more of the first reinforcing member and the second reinforcing member is not disposed near the top part of the main dome.

9. An electroacoustic transducer converting electric signals to sound waves or converting sound waves to electric signals, comprising:
a diaphragm configured to vibrate in response to the electric signals or to vibrate in response to the sound waves, wherein
the diaphragm is the diaphragm according to claim 1.
